(19) United States
(12) Patent Application Publication
(10) Pub. No.: US 2017/0293967 A1
(43) Pub. Date: Oct. 12, 2017

(54) Method and System for Dispatching an Order for a Product

(71) Applicant: MASTERCARD ASIA/PACIFIC PTE LTD, SINGAPORE (SG)

(72) Inventors: Benjamin Charles Gilbey, Singapore (SG); Vijin Venugopalan, Singapore (SG); Eric Jian Hui Lin, Singapore (SG)

(21) Appl. No.: 15/483,435

(22) Filed: Apr. 10, 2017

(30) Foreign Application Priority Data
Apr. 11, 2016 (SG) 10201602824T

(51) Int. Cl. G06Q 30/06; G06Q 20/20; G06Q 20/40; G06F 12/0875

(52) U.S. Cl. CPC G06Q 30/0635; G06F 12/0875; G06Q 20/202; G06Q 20/405; G06F 2212/60

(57) ABSTRACT

Methods and systems for dispatching an order for a product. The method including the steps of: receiving, at a dispatch module, data corresponding to a completion time for provision of the product by a merchant; receiving, at the dispatch module, data corresponding to a receipt time for receipt of the product by a consumer; comparing the completion time and the receipt time based on the respective data; and dispatching the order to an execution module to initiate provision of the product on a condition that the receipt time is approximately equal to the completion time.

### CROSS-REFERENCE TO RELATED APPLICATION

This application claims the benefit of and priority to Singapore Patent Application No. 10201602824T, filed Apr. 11, 2016. The entire disclosure of the above application is incorporated herein by reference.

### FIELD

The present disclosure relates broadly, but not exclusively, to methods and systems for dispatching an order for a product.

### BACKGROUND

This section provides background information related to the present disclosure which is not necessarily prior art.

In order to reduce customers' waiting time at a merchant's premises, some merchants are allowing customers to place orders for products before they arrive at the merchant's premises. For example, in the food and beverage (F&B) industry, fast food merchants allow customers to place orders ahead of time, i.e. before the customers reach the merchant's premises, and collect their food and beverages upon arrival at the merchant's premises. Customers typically use a mobile application installed on their mobile electronic devices, such as smart phones, to place their orders. Customers place their order and pay for their food and beverages in advance, and specify a pick-up time at the merchant's premises.

At the required time, the merchant prepares the order and the customers pick up their items. However, customers may not always indicate a suitable time for pick up, for example, they may be delayed by traffic, held up in meetings, etc.

When the customer arrives late, the food or beverage item may not be in optimal condition for consumption, for example, a hot coffee has gone cold, or a burger has sat around for too long. Consequently, food and beverage merchants may be delivering substandard items to their customers.

This problem is not restricted to the F&B industry. For example, some merchants allow customers to purchase products online (for example, using the merchant's website) and deliver the purchased products to the customers. The customer can specify a certain date/time for delivery of the ordered products. Similarly, customers may not always indicate a suitable time for delivery—for example, they may be delayed by traffic, held up in meetings, etc. Consequently, arrangements have to be made for re-delivery at a later date or time.

A need therefore exists to provide methods and systems for dispatching an order for a product that seek to address at least the above-mentioned problem(s).

### SUMMARY

This section provides a general summary of the disclosure, and is not a comprehensive disclosure of its full scope or all of its features. Aspects and embodiments of the disclosure are also set out in the accompanying claims.

According to a first aspect, there is provided a method for dispatching an order for a product comprising: receiving, at a dispatch module, data corresponding to a completion time for provision of the product by a merchant; receiving, at the dispatch module, data corresponding to a receipt time for receipt of the product by a consumer; comparing the completion time and the receipt time based on the respective data; and dispatching the order to an execution module to initiate provision of the product on a condition that the receipt time is approximately equal to the completion time.

According to a second aspect, there is provided a system for dispatching an order for a product comprising: a dispatch module that is configured to: receive data corresponding to a completion time for provision of the product by a merchant; receive data corresponding to a receipt time for receipt of the product by a consumer; compare the completion time and the receipt time based on the respective data; and dispatch the order to an execution module in communication with the dispatch module to initiate provision of the product on a condition that the receipt time is approximately equal to the completion time.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments of the disclosure will be better understood with reference to the following written description, in conjunction with the drawings, in which:

FIG. 1 is a schematic diagram illustrating flow of information during a method for dispatching an order for a product, according to an example embodiment;

FIG. 2 shows a flow chart illustrating a method for dispatching an order for a product according to an example embodiment;

FIG. 3 shows a schematic of a system for dispatching an order for a product according to an example embodiment; and

FIG. 4 shows an exemplary computing device suitable for executing the method for dispatching an order for a product.

### DETAILED DESCRIPTION

Embodiments of the present disclosure will be described, by way of example only, with reference to the drawings. The description and specific examples included herein are intended for purposes of illustration only and are not intended to limit the scope of the present disclosure Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as, electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present disclosure also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present disclosure also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a computer effectively, results in an apparatus that implements the steps of the preferred method.

Currently, customers can place their orders using their mobile electronic devices (such as smart phones, tablet computers, etc.) ahead of time, i.e., before the customers reach the merchant's premises. Customers typically use a mobile application (provided by the merchant) installed on their mobile electronic devices to place their orders and/or pay for their orders in advance. The mobile application allows customers to browse the merchant's products and specify a date/time to pick-up their order or for delivery of their order. To be able to pay for their orders, the mobile electronic devices have a mobile wallet provided by an issuer, payment network or smartphone vendor, or a card-on-file (COF) with a particular merchant. Card details, such as primary account number (PAN), expiry, card verification value (CVV), are stored in the mobile wallet or COF system. Card information is tokenized on the merchant or payment service provider (PSP)/payment facilitator (PF) platform, as known in the art. The mobile wallet or COF system is usually within the mobile application.

Each merchant typically has access to a backend, cloud computing-based platform that enables their customers to place and pay for their orders using the customers' mobile electronic devices through the merchant's mobile application. The backend platform is connected to the merchant's point-of-sale (POS) terminals in the merchant's premises.

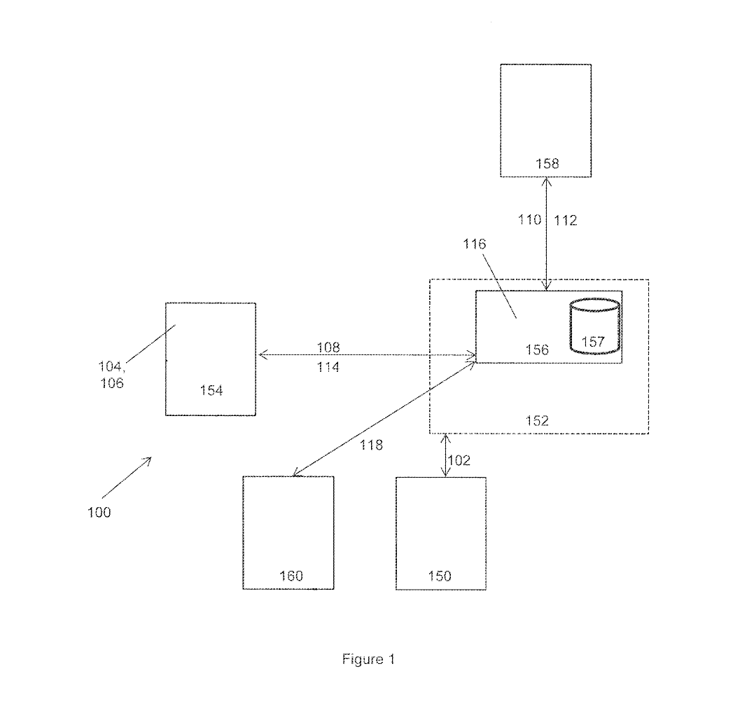

FIG. 1 is a schematic diagram 100 illustrating flow of information during a method for dispatching an order for a product, according to an example embodiment. The method can be broadly divided into three phases—(1) an initial set-up phase, (2) an ordering and payment phase, and (3) an order dispatch and preparation phase.

The initial set-up phase comprises steps 102 and 104, which will now be described in detail. At step 102, a merchant uses a merchant module 150 to specify a management platform (which may be a standalone server or a cloud computing-based platform) 152 an average completion time it takes to provide a product (e.g. time to prepare a food/beverage item). The merchant module 150 is in communication with the platform 152 as per techniques known in the art. As an example, a coffeehouse can specify that it takes 5 minutes to prepare a cup of coffee, regardless of the type of coffee (latte, cappuccino, iced coffee, etc.). Alternatively, the merchant can specify different average completion times for a product depending on the store location and/or time of day. For instance, during a peak period, it may take longer to prepare a cup of coffee. A merchant may also have a number of outlets and smaller outlets having less manpower that may take longer to prepare a cup of coffee. In this manner, the merchant can fine-tune the preparation time of a product according to how busy a particular outlet is at certain times of the day.

At step 104, a customer downloads and installs a mobile application provided by the merchant on their mobile electronic device (hereinafter referred to as consumer module 154). The customer also links his/her mobile payment wallet or enters his/her card details into the merchant card-on-file (COF) platform to enable payments to be made electronically, as known in the art.

The initial set-up phase, comprising steps 102 and 104, can be performed once, unless subsequent changes need to be made. In other words, steps 102 and 104 do not need to be performed every time an order for a product is placed. For example, if the merchant needs to change the average completion time or if the customer has changed his card details, steps 102 and 104 can be performed again. It will be appreciated that steps 102 and 104 are not necessarily performed sequentially, i.e., step 104 can be performed before 102, or steps 102 and 104 can be performed in parallel.

After the initial set-up phase, the ordering and payment phase can be performed. The ordering and payment phase comprises steps 106, 108, 110 and 112 as described below.

At step 106, the customer creates and places an order using the mobile application installed on his/her consumer module 154, for example, to order a medium latte from the coffeehouse. When placing the order, the customer can specify a location and a time of day for self-collection (i.e. a receipt time for receipt of the product). The receipt time that is specified by the customer depends on the completion time specified by the merchant in step 102. For example, if the time specified to prepare the medium latte at a particular outlet is 5 minutes, the customer is not allowed to specify a shorter receipt time (e.g. 4 minutes from the ordering time). The management platform 152, together with consumer module 154, may implement logic which constrains the choice of receipt time accordingly. Once the customer has decided which product(s) to purchase, he/she places an order of the product(s) and checks out using his/her mobile wallet or COF linked to the merchant mobile application. At step 108, the order is transmitted to a dispatch module 156 with a payment authorization request. The dispatch module 156 can be implemented as part of the merchant's cloud computing-based platform 152.

At step 110, the dispatch module 156 relays the payment authorization request to a payment module 158 for processing. The dispatch module 156 is in communication with the payment module 158 as per techniques known in the art. For example, the payment can be sent to a payment network for processing by a payment service provider (PSP), acquirer, payment facilitator and/or issuer, as known in the art. There may be more than one payment module in communication with each other, each payment module administered by a different entity (e.g. PSP, acquirer, payment facilitator, issuer). The plurality of payment modules can be considered as part of the payment network. If the payment is authorized, a payment authorization message is received across the payment network and sent to the dispatch module 156 at step 112. After the ordering and payment phase is performed, the order dispatch and preparation phase commences. The order dispatch and preparation phase comprises steps 114, 116 and 118.

After the payment authorization message is received by the dispatch module 156, the order is confirmed on the dispatch module 156 and an order confirmation message is sent to the consumer module 154 at step 114 to notify the customer that payment has been made and the order has been confirmed.

At step 116, the dispatch module 156 compares the merchant-specified completion time of the product and the customer-specified receipt time and dispatches the order (at step 118) to an execution module 160, depending on the result of the comparison. The completion time may be a timestamp/absolute time (e.g., “5:30 pm; 1 Jan. 2016”) or a time interval (e.g., 15 minutes). Similarly, the receipt time may be a timestamp or a time interval. A clock module (not shown) that is able to provide a current time can be used to convert one time format (e.g., timestamp) to another time format (e.g., time interval) and vice versa. For example, if the current time is 4:00 pm and the time interval is 15 minutes, the clock module can be used to determine the corresponding timestamp, i.e., 4:15 pm. In other words, the data corresponding to the completion and/or receipt time may be computed based on a single absolute time value (i.e., timestamp) or based on a current time plus a time interval. The step 116 of comparing the completion time and receipt time may involve comparing times having a same format, e.g., both the completion time and receipt time are timestamps. The dispatch module 156 is in communication with the execution module 160, as per techniques known in the art. If the receipt time is approximately equal to the completion time (e.g., a customer specifies the minimum receipt time available for a particular outlet and time of day), the order is dispatched (or released) to the execution module 160 immediately. For example, if the receipt time is within a few seconds of the completion time, or if the receipt time is within a certain percentage (e.g., ±5%) of the completion time, the receipt time can be considered to be approximately equal to the completion time. The execution module 160 is typically located at a merchant's premises and may be in the form of a point-of-sale (POS) terminal. Once the order is received at the POS terminal, the merchant can start preparation of the order in anticipation of timely arrival of the customer. The customer is informed that their order is being prepared, and that they have to arrive on time so that the food item does not become unsuitable for consumption. The customer can be notified by in-application notification, SMS or email that is sent to his/her consumer module 154. For example, if the customer-specified receipt time is 5 minutes and the merchant-specified completion time is also 5 minutes, the customer is immediately prompted to make their way to the outlet for pickup to ensure product is in an optimal condition. At the same time, the order is immediately dispatched (or released) to the execution module 160.

On the other hand, if the receipt time is more than or greater than the completion time (e.g. a customer specifies an order collection time that is longer than or later than the minimum completion time specified by the merchant for a particular outlet and time of day), the order is held in a cache 157 or buffer of the dispatch module 156. In other words, the order is not immediately dispatched (or released) to the execution module 160. Only when the receipt time is approximately equal to the completion time, the order is dispatched (or released) to the execution module 160. Continuing from the example above, a coffeehouse specifies that it takes 5 minutes to prepare a cup of coffee. If the customer-specified receipt time is 15 minutes, the order is held in the dispatch module 156 until 5 minutes before the order is due to be collected. Only when the minimum order preparation time (i.e., completion time) is reached (5 minutes) is the order sent from the cloud-based dispatch module 156 to the execution module 160 (e.g., POS terminal) for the merchant to start preparation of the order.

In an implementation, a timing module (not shown) that is part of the dispatch module 156 may be used to regularly determine when the minimum order preparation time is reached in order to dispatch the order to the execution module 160. For example, the timing module may be configured as a countdown timer such that the difference between the receipt time and the completion time is constantly being determined, and the countdown timer is set to trigger a signal to dispatch the order when the receipt time is approximately equal to the completion time.

In an implementation, if the receipt time is specified to be longer than the completion time, the merchant can choose to automatically confirm with the customer his/her receipt time. Continuing from the example above where the completion time to prepare a cup of coffee is specified as 5 minutes, at 10 minutes prior to the receipt time designated by the customer, the cloud computing-based platform 152 or the dispatch module 156 can be configured to automatically trigger an in-app notification to the customer on his consumer module 154, requesting the customer to either confirm the receipt time, or choose a new time to receive the order (i.e., an extension of the receipt time). If the user confirms the original receipt time, then the order is held in the dispatch module 156 until the time remaining to the receipt time is equal to the completion time (in the event that the completion time is an interval, e.g., 5 minutes before the order is due to be collected). Alternatively, the customer has the option of extending the original receipt time, in case he/she is delayed and needs more time to collect the order. For example, the user may be stuck in traffic and so may change the pickup time and add an extra 10 minutes. In such a case, the order is held in the dispatch module 156 until the time remaining to the receipt time is equal to the completion time (in the event that the completion time is an interval, e.g., 5 minutes before the order is due to be collected), after which it is dispatched to the execution module 160.

The embodiment described above relates to self-collection of an order of food/beverage item(s) by consumers at a merchant's food and beverage outlet. The consumer indicates a time of day (“receipt time”) for self-collection (T1). The merchant pre-specifies on their cloud-based dashboard the average completion time (X) it takes a particular outlet to prepare the food/beverage item(s) of the order. The order is dispatched to an execution module (e.g., a POS terminal at the merchant's premises) when the current time (T2) is later than or approximately equal to T1−X. For example, the consumer indicates the receipt time (T1) as 5:00 pm and the merchant specified average completion time (X) is 5 minutes. When the current time (T2) is later than or approximately equal to T1−X, i.e., 4:55 pm or later, the order is dispatched to the execution module. When the current time (T2) is earlier than T1−X, i.e., 4:54 pm or earlier, an in-app notification may be sent to the consumer, asking the consumer to either confirm the receipt time, or choose a new receipt time. If the original receipt time is extended/postponed and a new receipt time (T1B) is chosen (e.g., 5:15 pm), the order is dispatched to the execution module when T2 is later than or approximately equal to T1B−X, i.e., 5:10 pm or later.

Other embodiments may relate to applications besides self-collection of an order of food/beverage item(s), including but not limited to: (i) real-time delivery of products (e.g., courier services), (ii) advance booking of taxis/limousines and (iii) booking of facilities.

In the case of real-time delivery of products, the consumer indicates a time of day (“receipt time”) for receiving the product(s) (T1). The merchant (e.g., courier service) specifies on their cloud-based dashboard the average delivery time (“completion time”, X) it takes to deliver the products based on a real-time location of delivery personnel. The delivery order is dispatched to an execution module (e.g. a hand-held mobile device carried by the delivery personnel which is capable of displaying delivery instructions) when the current time (T2) is later than or approximately equal to T1−X. For example, the consumer indicates the receipt time (T1) as 5:00 pm, and the average delivery time (X) is specified by the courier service as 30 minutes. When the current time (T2) is later than or approximately equal to T1−X, i.e., 4:30 pm or later, the order is dispatched to the execution module. When the current time (T2) is earlier than T1−X, i.e., 4:29 pm or earlier, an in-app notification may be sent to the consumer, asking the consumer to either confirm the receipt time, or choose a new receipt time. If the original receipt time is extended/postponed and a new receipt time (T1B) is chosen (e.g., 5:15 pm), the order is dispatched to the execution module when T2 is later than or approximately equal to T1B−X, i.e., 4:45 pm or later. Oftentimes, consumers may not be present when delivery personnel arrive and arrangements have to be made for delivery of the products at a later date. In such an implementation, products are advantageously delivered to consumers only when they are ready to receive the products.

In the case of advance booking of taxis/limousines, the consumer indicates a time of day (“receipt time”) for arrival of the taxi/limousine (T1), i.e., a “pick-up” time. The merchant specifies on their cloud-based dashboard a completion time (X), which is either based on the average travelling time from a car park/garage/headquarters to the consumer's pick-up location or based on a real-time location of the taxi/limousine. The pick-up order is dispatched to an execution module (e.g., a mobile device in the taxi/limousine which is capable of displaying passenger pick-up instructions) when the current time (T2) is later than or approximately equal to T1−X. For example, the consumer indicates the receipt time (T1) as 5:00 pm and the average completion time (X) is specified by the taxi/limousine operator as 30 minutes. When the current time (T2) is later than or approximately equal to T1−X, i.e., 4:30 pm or later, the order is dispatched to the execution module. When the current time (T2) is earlier than T1−X, i.e., 4:29 pm or earlier, an in-app notification may be sent to the consumer, asking the consumer to either confirm the receipt time, or choose a new receipt time. If the original receipt time is extended/postponed and a new receipt time (T1B) is chosen (e.g., 5:15 pm), the order is dispatched to the execution module when T2 is later than or approximately equal to T1B−X, i.e., 4:45 pm or later. Oftentimes, passengers may not be ready when taxis/limousines arrive at the pick-up location and drivers have to wait for the passengers. In such an implementation, taxis/limousines advantageously arrive at a pick-up location only when passengers are ready to be picked-up.

In the case of booking of facilities, the consumer indicates a time of day (“receipt time”, T1) for usage of a facility, such as a meeting room, function room, karaoke room, etc. The merchant/facility operator specifies on their cloud-based dashboard an average preparation time to clean-up/prepare the facility (“completion time”, X). The order is dispatched to an execution module (e.g., a mobile device carried by service staff which is capable of displaying facility preparation instructions) when the current time (T2) is later than or approximately equal to T1−X. For example, the consumer indicates the receipt time (T1) as 5:00 pm and the average completion time (X) is specified by the facility operator as 30 minutes (i.e., 4:30 pm). When the current time (T2) is later than or approximately equal to T1−X, i.e., 4:30 pm or later, the order is dispatched to the execution module. When the current time (T2) is earlier than T1−X, i.e., 4:29 pm or earlier, an in-app notification may be sent to the consumer, asking the consumer to either confirm the receipt time, or choose a new receipt time. If the original receipt time is extended/postponed and a new receipt time (T1B) is chosen (e.g., 5:15 pm), the order is dispatched to the execution module when T2 is later than or approximately equal to T1B−X, i.e., 4:45 pm or later. Oftentimes, users may have to wait for facilities to be prepared by facility operators assigned cleaning staff on an ad-hoc basis rather than in a structured manner (e.g., depending on which facility is to be used next). In such an implementation, facilities are advantageously prepared in time for arrival of users.

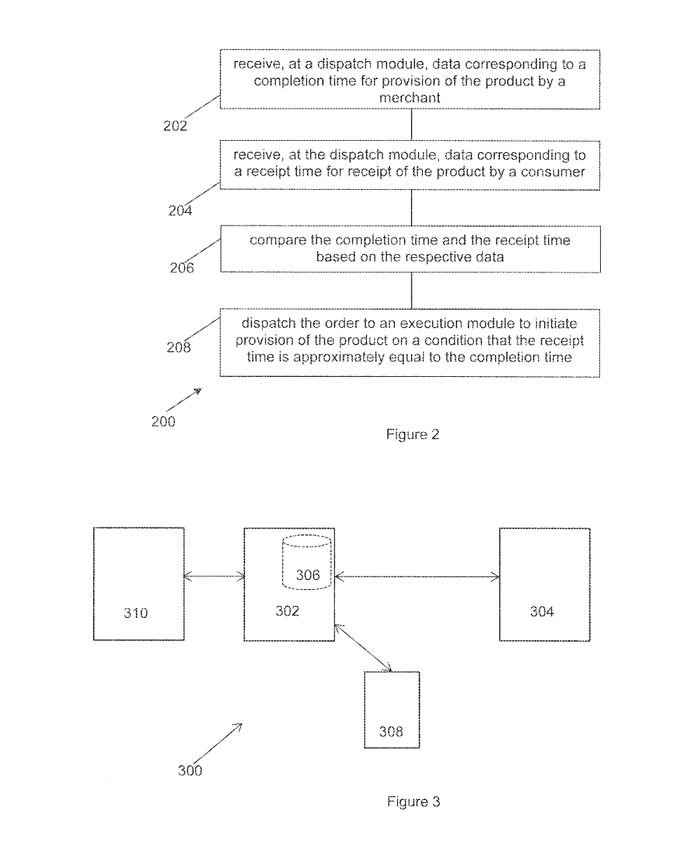

FIG. 2 shows a flow chart illustrating a method 200 for dispatching an order for a product according to an example embodiment. The method 200 comprises the step 202 of receiving, at a dispatch module, data corresponding to a completion time for provision of the product by a merchant. Step 204 involves receiving, at the dispatch module, data corresponding to a receipt time for receipt of the product by a consumer. At step 206, the completion time and the receipt time are compared based on the respective data received at steps 202 and 204. Step 208 involves dispatching the order for the product to an execution module to initiate provision of the product on a condition that the receipt time is approximately equal to the completion time. For example, if the receipt time is within a few seconds of the completion time, or if the receipt time is within a certain percentage (e.g., ±5%) of the completion time, the receipt time can be considered to be approximately equal to the completion time. Some of the steps 202, 204, 206, 208 are not necessarily performed sequentially. For example, step 204 may be performed before step 202, or steps 202 and 204 are performed in parallel.

The data corresponding to the completion time may comprise a timestamp/absolute time (e.g., “5:30 pm; 1 Jan. 2016”) and/or a time interval (e.g., 15 minutes). Similarly, the data corresponding to the receipt time may also comprise a timestamp and/or a time interval. A clock module that is able to provide a current time can be used to convert one time format (e.g., timestamp) to another time format (e.g. time interval) and vice versa. For example, if the current time is 4:00 pm and the time interval is 15 minutes, the clock module can be used to determine the corresponding timestamp, i.e., 4:15 pm. In other words, the data corresponding to the completion and/or receipt time may be computed based on a single absolute time value (i.e., timestamp) or based on a current time plus a time interval. The step 206 of comparing the completion time and the receipt time may involve comparing times having a same format, e.g., both the completion time and receipt time are timestamps.

Step 206 described above, which involves comparing the completion time and the receipt time based on the respective data, may further comprise a sub-step of holding the order in a cache of the dispatch module on a condition that the receipt time is more or later than the completion time, before dispatching the order. In other words, at step 206, the completion time and the receipt time are compared and if the receipt time is more or later than the completion time, the order is not dispatched to the execution module. For example, if the data corresponding to the completion and receipt time comprise a timestamp (e.g., “5:30 pm on 1 Jan. 2016”), the comparison is based on whether the receipt time is earlier, approximately the same, or later than the completion time. The comparing step may be continuously performed, i.e., recursively, and once the receipt time is approximately equal to the completion time, the order is dispatched to the execution module. During the comparing step, data corresponding to a current time may be used to facilitate the comparison. For example, as described above, if a receipt time, completion time and current time are denoted as T1, X and T2 respectively, the comparison may be based on whether T2 is earlier, approximately the same, or later than T1−X.

The execution module may be part of, or be in the form of, a Point-of-Sale (POS) terminal. In such a case, after the POS terminal receives the order from the dispatch module, the POS terminal generates a message to the merchant to initiate provision of the product.

If the receipt time is specified by the consumer to be longer than the merchant-specified completion time, the merchant can choose to automatically confirm with the customer his/her receipt time beforehand. A notification can be sent to the customer, requesting the customer to either confirm the receipt time, or choose a new receipt time (i.e., an extension of the receipt time). The consumer has the option of extending the original receipt time in case he/she is delayed and needs more time to receive the order. For example, the user may be stuck in traffic and so may change a receipt time and add an extra 10 minutes. In such a case, the method 200 can further include the steps of: (A) receiving, at the dispatch module, a request for an extension of the receipt time (i.e., request for a new receipt time) by the consumer; (B) updating the data corresponding to the receipt time in accordance with the request for the extension; (C) comparing the completion time and the extended receipt time based on the respective data; and (D) dispatching the order to the execution module to initiate provision of the product on a condition that the extended receipt time is approximately equal to the completion time. The step (C), which involves comparing the completion time and the extended receipt time based on the respective data, may further include the sub-step of holding the order in the cache of the dispatch module on a condition that the extended receipt time is more than or greater than the completion time, before dispatching the order.

Prior to steps (A), (B) and (C) above, if the receipt time is more than or greater than the completion time, the method 200 may further include: transmitting, to a consumer module, a request for confirmation that the product is to be received at the receipt time. The order is held in the cache of the dispatch module until an affirmative confirmation is received from the consumer module in response to the request. On the other hand, a query is transmitted to the consumer module on a condition that a negative confirmation is received from the consumer module in response to the request. In an implementation, the query is whether the request for the extension of the receipt time (see step (A) above) is required by the consumer.

Steps 202, 204, 206 and 208 described above are preferably performed after the customer has paid for the product. Accordingly, prior to the execution of steps 202, 204, 206 and 208, the method 200 may further include the steps of: placing the order for the product using a consumer module; transmitting a payment authorization request corresponding to the order for the product from the consumer module to the dispatch module; relaying the payment authorization request from the dispatch module to a payment module for processing of the payment authorization request; and transmitting, from the consumer module to the dispatch module, the data corresponding to the receipt time for receipt of the product by the consumer on a condition that the payment module issues a payment authorization message.

It is possible for merchants to specify a number of different completion times for provision of a particular product. For example, during a peak period, it may take longer to prepare a cup of coffee. As a further example, a merchant may operate a number of outlets and smaller outlets having less manpower may take longer to prepare a cup of coffee. Accordingly, the method 200 may further include: receiving, at the dispatch module, data corresponding to a plurality of different completion times for provision of the product by the merchant; selecting one of the plurality of different completion times based on a pre-determined condition; comparing the selected completion time and the receipt time based on the respective data; and dispatching the order to the execution module to initiate provision of the product on a condition that the receipt time is approximately equal to the selected completion time. The pre-determined condition includes, but is not limited to, a time of a day (e.g., peak period or off-peak period) or a location of the merchant (i.e., different outlets taking different amounts of time to prepare a product).

FIG. 3 shows a schematic of a system 300 for dispatching an order for a product according to an example embodiment. The system 300 includes a purpose-built computing device in the form of a dispatch module 302. The dispatch module 302 is configured to, at least: receive data corresponding to a completion time for provision of the product by a merchant; receive data corresponding to a receipt time for receipt of the product by a consumer; compare the completion time and the receipt time based on the respective data; and dispatch the order to an execution module 304 that is in communication with the dispatch module 302 to initiate provision of the product on a condition that the receipt time is approximately equal to the completion time. For example, if the receipt time is within a few seconds of the completion time, or if the receipt time is within a certain percentage (e.g., ±5%) of the completion time, the receipt time can be considered to be approximately equal to the completion time. When the dispatch module 302 is comparing the completion time and the receipt time, the dispatch module 302 can be further configured to hold the order in a cache 306 on a condition that the receipt time is more than or greater than the completion time, before dispatching the order. The cache 306 may be realized using a memory module that is part of the dispatch module 302.

The data corresponding to the completion time may comprise a timestamp (e.g., “5:30 pm; 1 Jan. 2016”) or a time interval (e.g., 15 minutes). Similarly, the data corresponding to the receipt time may also comprise a timestamp or a time. A clock module (not shown) that is able to provide a current time can be used to convert one time format (e.g., timestamp) to another time format (e.g., time interval) and vice versa. For example, if the current time is 4:00 pm and the time interval is 15 minutes, the clock module can be used to determine the corresponding timestamp, i.e., 4:15 pm. In other words, the data corresponding to the completion and/or receipt time may be computed based on a single absolute time value (i.e., timestamp) or based on a current time plus a time interval.

In an implementation, the dispatch module 302 can be further configured to: receive a request for an extension of the receipt time by the consumer from a consumer module 308 that is in communication with the dispatch module 302; update the data corresponding to the receipt time in accordance with the request for the extension; compare the completion time and the extended receipt time based on the respective data; and dispatch the order to the execution module 304 to initiate provision of the product on a condition that the extended receipt time is approximately equal to the completion time. When the dispatch module 302 is comparing the completion time and the extended receipt time, the dispatch module 302 can be further configured to hold the order in the cache on a condition that the extended receipt time is more than or greater than the completion time, before dispatching the order.

If the receipt time is more than or greater than the completion time, the dispatch module 302 can be further configured to: transmit, to a consumer module 308 in communication with the dispatch module 302, a request for confirmation that the product is to be received at the receipt time. The dispatch module 302 is configured to hold the order in the cache until an affirmative confirmation is received from the consumer module 308 in response to the request. The dispatch module 302 is also configured to transmit a query to the consumer module 308 on a condition that a negative confirmation is received from the consumer module 308 in response to the request. The query may be whether the request for the extension of the receipt time is required by the consumer.

In an implementation, the dispatch module 302 can be further configured to: receive a payment authorization request corresponding to the order for the product; relay the payment authorization request to a payment module 310 that is configured to process the payment authorization request and is in communication with the dispatch module 302; receive a payment authorization message from the payment module 310; and dispatch the order to the execution module 304 to initiate provision of the product on a condition that the payment authorization message is received.

As mentioned above, it is possible for merchants to specify a number of different completion times for provision of a particular product. For example, during a peak period, it may take longer to prepare a cup of coffee. As a further example, a merchant may operate a number of outlets and smaller outlets having less manpower may take longer to prepare a cup of coffee. In an implementation, the dispatch module 302 can be further configured to: receive data corresponding to a plurality of different completion times for provision of the product by the merchant; select one of the plurality of different completion times based on a pre-determined condition; compare the selected completion time and the receipt time based on the respective data; and dispatch the order to the execution module 304 to initiate provision of the product on a condition that the receipt time is approximately equal to the selected completion time. The pre-determined condition includes, but is not limited to, a time of a day (e.g. peak period or off-peak period) or a location of the merchant (i.e. different outlets taking different amounts of time to prepare a product).

The execution module 304 may comprise, or be in the form of, a Point-of-Sale (POS) terminal that is configured to generate a message to the merchant to initiate provision of the product after the order is received at the POS terminal from the dispatch module 302.

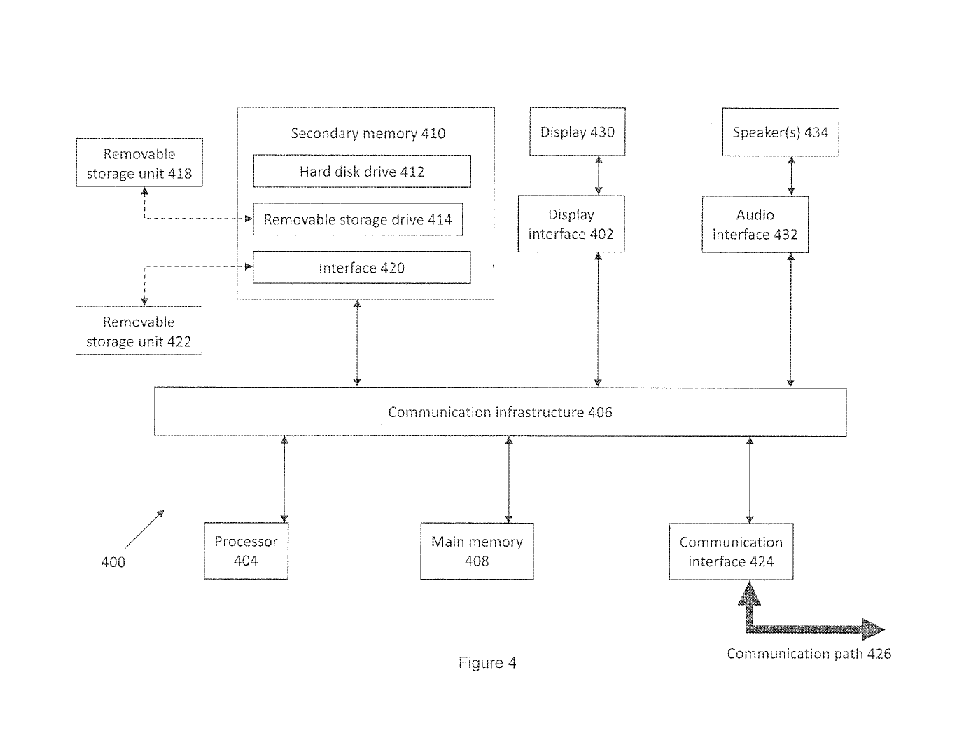

FIG. 4 depicts an exemplary computer or computing device 400, hereinafter interchangeably referred to as a computer system 400, where one or more such computing devices 400, or one or more components of the computer system 400, may be used to realize the dispatch module 302 described above. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 418 in a well-known manner. The removable storage medium 418 may include magnetic tape, optical disk, non-volatile memory storage medium, or the like, which is read by and written to by removable storage drive 414. As will be appreciated by persons skilled in the relevant art(s), the removable storage medium 418 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 420. Examples of a removable storage unit 422 and interface 420 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 420 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments, the communication interface 424 permits data to be transferred between the computing device 400 and a data communication network, such as a public data or private data communication network. The communication interface 424 may be used to exchange data between different computing devices 400 which such computing devices 400 form part of an interconnected computer network. Examples of a communication interface 424 can include a modem, a network interface (such as an Ethernet card), a communication port (such as a serial, parallel, printer, GPIB, IEEE 1394, RJ45, USB), an antenna with associated circuitry, and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface 424 via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage medium 418, removable storage unit 422, a hard disk installed in storage drive 412, or a carrier wave carrying software over communication path 426 (wireless link or cable) to communication interface 424. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites, and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 420. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments, one or more features of the computing device 400 may be omitted. Also, in some embodiments, one or more features of the computing device 400 may be combined together. Additionally, in some embodiments, one or more features of the computing device 400 may be split into one or more component parts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for dispatching an order for a product, the method comprising:
receiving, at a dispatch module, data corresponding to a completion time for provision of the product by a merchant;
receiving, at the dispatch module, data corresponding to a receipt time for receipt of the product by a consumer;
comparing the completion time and the receipt time based on the respective data; and
dispatching the order to an execution module to initiate provision of the product on a condition that the receipt time is approximately equal to the completion time.

2. The method as claimed in claim 1, wherein comparing the completion time and the receipt time further comprises holding the order in a cache of the dispatch module on a condition that the receipt time is greater than the completion time, before dispatching the order.

3. The method as claimed in claim 2, further comprising:
receiving, at the dispatch module, a request for an extension of the receipt time by the consumer;
updating the data corresponding to the receipt time in accordance with the request for the extension;
comparing the completion time and the extended receipt time based on the respective data; and
dispatching the order to the execution module to initiate provision of the product on a condition that the extended receipt time is approximately equal to the completion time.

4. The method as claimed in claim 3, wherein comparing the completion time and the extended receipt time further comprises holding the order in the cache of the dispatch module on a condition that the extended receipt time is greater than the completion time, before dispatching the order.

5. The method as claimed in claim 2, wherein on the condition that the receipt time is greater than the completion time, the method further comprises:
transmitting, to a consumer module, a request for confirmation that the product is to be received at the receipt time; and
holding the order in the cache of the dispatch module until an affirmative confirmation is received from the consumer module in response to the request.

6. The method as claimed in claim 3, wherein on the condition that the receipt time is greater than the completion time, the method further comprises:
transmitting, to a consumer module, a request for confirmation that the product is to be received at the receipt time; and
transmitting a query to the consumer module on a condition that a negative confirmation is received from the consumer module in response to the request, the query being whether the request for the extension of the receipt time is required by the consumer.

7. The method as claimed in claim 1, wherein the data corresponding to the completion time comprises a timestamp; and/or wherein the data corresponding to the receipt time comprises a timestamp.

8. (canceled)

9. The method as claimed in claim 1, further comprising:
placing the order for the product using a consumer module;
transmitting a payment authorization request corresponding to the order for the product to the dispatch module;
relaying the payment authorization request from the dispatch module to a payment module for processing of the payment authorization request; and
transmitting, from the consumer module to the dispatch module, the data corresponding to the receipt time for receipt of the product by the consumer on a condition that the payment module issues a payment authorization message.

10. The method as claimed in claim 1, further comprising:
receiving, at the dispatch module, data corresponding to a plurality of different completion times for provision of the product by the merchant;
selecting one of the plurality of different completion times based on a pre-determined condition;
comparing the selected completion time and the receipt time based on the respective data; and
dispatching the order to the execution module to initiate provision of the product on a condition that the receipt time is approximately equal to the selected completion time.

11. (canceled)

12. The method as claimed in claim 1, wherein the execution module comprises a Point-of-Sale (POS) terminal, and wherein the method further comprises:
generating, at the POS terminal, a message to the merchant to initiate provision of the product after the order is received at the POS terminal from the dispatch module.

13. A system for dispatching an order for a product, the system comprising:
a dispatch module configured to:
receive data corresponding to a completion time for provision of the product by a merchant;
receive data corresponding to a receipt time for receipt of the product by a consumer;
compare the completion time and the receipt time based on the respective data; and
dispatch the order to an execution module in communication with the dispatch module to initiate provision of the product on a condition that the receipt time is approximately equal to the completion time.

14. The system as claimed in claim 13, wherein during comparing the completion time and the receipt time, the dispatch module is further configured to hold the order in a cache on a condition that the receipt time is greater than the completion time, before dispatching the order.

15. The system as claimed in claim 14, wherein the dispatch module is further configured to:
receive a request for an extension of the receipt time by the consumer from a consumer module in communication with the dispatch module;
update the data corresponding to the receipt time in accordance with the request for the extension;
compare the completion time and the extended receipt time based on the respective data; and
dispatch the order to the execution module to initiate provision of the product on a condition that the extended receipt time is approximately equal to the completion time.

16. The system as claimed in claim 15, wherein during comparing the completion time and the extended receipt time, the dispatch module is further configured to hold the order in the cache on a condition that the extended receipt time is greater than the completion time, before dispatching the order.

17. The system as claimed in claim 14, wherein on the condition that the receipt time is greater than the completion time, the dispatch module is further configured to:
transmit, to a consumer module in communication with the dispatch module, a request for confirmation that the product is to be received at the receipt time; and
hold the order in the cache until an affirmative confirmation is received from the consumer module in response to the request.

18. The system as claimed in claim 15, wherein on the condition that the receipt time is greater than the completion time, the dispatch module is further configured to:
transmit, to a consumer module in communication with the dispatch module, a request for confirmation that the product is to be received at the receipt time; and
transmit a query to the consumer module on a condition that a negative confirmation is received from the consumer module in response to the request, the query being whether the request for the extension of the receipt time is required by the consumer.

19. The system as claimed in claim 13, wherein the data corresponding to the completion time comprises a timestamp or a specified length of time; and/or
wherein the data corresponding to the receipt time comprises a timestamp or a specified length of time.

20. (canceled)

21. The system as claimed in claim 13, wherein the dispatch module is further configured to:
receive a payment authorization request corresponding to the order for the product;
relay the payment authorization request to a payment module in communication with the dispatch module, the payment module configured to process the payment authorization request;
receive a payment authorization message from the payment module; and
dispatch the order to the execution module to initiate provision of the product on a condition that the payment authorization message is received.

22. The system as claimed in claim 13, wherein the dispatch module is further configured to:
receive data corresponding to a plurality of different completion times for provision of the product by the merchant;
select one of the plurality of different completion times based on a pre-determined condition;
compare the selected completion time and the receipt time based on the respective data; and
dispatch the order to the execution module to initiate provision of the product on a condition that the receipt time is approximately equal to the selected completion time.

23. (canceled)

24. The system as claimed in claim 13, wherein the execution module comprises a Point-of-Sale (POS) terminal configured to generate a message to the merchant to initiate provision of the product after the order is received at the POS terminal from the dispatch module.
